(19) United States
(12) Patent Application Publication
(10) Pub. No.: US 2007/0163440 A1
(43) Pub. Date: Jul. 19, 2007

(54) GAS SEPARATION TYPE SHOWERHEAD

(75) Inventors: Kyung Soo Kim, Seoul (KR); Guen Hag Bae, Seongnam-si (KR); Ho Sik Kim, Yongin-si (KR)

Correspondence Address: CANTOR COLBURN, LLP, 55 GRIFFIN ROAD SOUTH, BLOOMFIELD, CT, 06002, US

(73) Assignee: ATTO CO., LTD., Shiheung-si (KR)

(21) Appl. No.: 11/624,749

(22) Filed: Jan. 19, 2007

(30) Foreign Application Priority Data
Jan. 19, 2006 (KR) 1020060005890
Mar. 2, 2006 (KR) 1020060019815
Jul. 21, 2006 (KR) 1020060068360
Jan. 26, 2006 (KR) 1020060008153

(51) Int. Cl. B03C 3/011

(52) U.S. Cl. 96/52; 95/58; 95/78; 96/60; 96/88

(57) ABSTRACT

Provided is a gas separation type showerhead for effective energy supply. The gas separation type showerhead includes: a gas supply module to which a first gas and a second gas are separately supplied; a gas separation module in which the supplied first and second gases are separately dispersed; and a gas injection module which is a multi-hollow cathode having a plurality of holes and in which the first and second gases separately dispersed are ionized in the holes to be commonly dispersed.

### BACKGROUND OF THE INVENTION

1. Field of the Invention

The present invention relates to a showerhead used in a semiconductor manufacturing process, and more particularly, to a gas separation type showerhead in which two or more gases are separately provided.

2. Description of the Related Art

In general, semiconductor manufacturing processes such as an ALD process and a CVD process are carried out inside a chamber provided with a shaft and a showerhead, wherein the shaft has a heater function to support a semiconductor wafer and the showerhead injects gas required for the processes.

Taking a general CVD process for example, when a precursor containing a material to be deposited is injected into the chamber through the showerhead while in a gas state, a chemical reaction occurs within the chamber, and thus deposition takes place. In this process, a high temperature has to be maintained inside the chamber for the chemical reaction. Therefore, there is a demerit in that process efficiency deteriorates.

To solve this problem, a plasma enhanced (PE)-CVD device has been widely used in recent years. Unlike a typical CVD device, the PE-CVD device performs a process by using plasma in a state that reaction gases are activated. Thus, there are various advantages in that the process can be performed at a lower temperature in comparison with the typical CVD device.

A representative example of the PE-CVD process is a silicon nitride (SiN) layer deposition. In general, a reaction gas required for deposition is injected inside the chamber. When a desired pressure is determined, and the temperature of a substrate is determined to be about below 600° C., the injected gas is decomposed to be a plasma state by using RF power so that the silicon nitride layer is deposited on the substrate. In this case, SiH₄ and NH₃ are used as the reaction gases. The silicon nitride layer deposited on a wafer by using the PE-CVD device contains a hydrogen component more than a predetermined amount. When the hydrogen component is infiltrated inside a transistor, a problem occurs in that a transistor characteristic deteriorates.

In order to solve this problem, an effort has conventionally been made to obtain a silicon nitride layer having minimum hydrogen content by regulating a composition ratio of the reaction gases (SiH₄/NH₃). However, there has been a limit in reducing the hydrogen content to the extent of satisfaction.

In a general showerhead, reaction gases are ionized in advance before the reaction gases are supplied to the showerhead. Alternatively, the reaction gases are ionized within the chamber after the reaction gases are injected from the showerhead.

In the case that the reaction gases are ionized in advance, a problem lies in that ions may be re-bonded while passing through the showerhead. On the other hand, in the case that the reaction gases are ionized within the chamber after being injected from the showerhead, a substrate may be damaged when high ionization energy is supplied into the chamber.

Moreover, in the conventional showerhead for injection two or more gases, the two or more gases are separately injected. Therefore, there is a problem in that the gases are not uniformly mixed.

### SUMMARY OF THE INVENTION

The present invention provides a gas separation type showerhead that can minimize hydrogen content, has a structure of multiple block stacks, and can enhance diversity and efficiency of process by using a common injection module even when using heterogeneous gases.

The present invention also provides a gas separation type showerhead in which a high plasma density is obtained by means of a multi-hollow cathode, and thus substrate cleaning, surface processing, or deposition can be effectively carried out.

According to an aspect of the present invention, there is provided a gas separation type showerhead comprising: a gas supply module to which a first gas and a second gas are separately supplied; a gas separation module in which the supplied first and second gases are separately dispersed; and a gas injection module which includes a plurality of holes and in which the first and second gases separately dispersed are commonly injected through the holes, wherein a lower part of the gas separation module, through which the first and second gases are vented to the gas injection module, has a variable height.

According to another aspect of the present invention, there is provided a gas separation type showerhead comprising: a gas supply module to which a first gas and a second gas are separately supplied; a gas separation module in which the supplied first and second gases are separately dispersed; and a gas injection module which is a multi-hollow cathode having a plurality of holes and in which the first and second gases separately dispersed are ionized in the holes to be commonly dispersed.

According to still another aspect of the present invention, there is provided a gas separation type showerhead comprising: a gas supply module to which a first gas and a second gas are separately supplied; a gas separation module in which the supplied first and second gases are separately dispersed, and at least one of the first and second gases are ionized; and a gas injection module which includes a plurality of holes and in which the first and second gases separately dispersed are commonly injected through the holes, wherein at least a part of the gas injection module is an insulator.

### BRIEF DESCRIPTION OF THE DRAWINGS

The above and other features and advantages of the present invention will become more apparent by describing in detail exemplary embodiments thereof with reference to the attached drawings in which:

FIG. 1 shows a gas separation type showerhead of the present invention;

FIG. 2 shows a three-dimensional cross-section of a gas separation module and a gas injection module;

FIGS. 3 and 4 show locations of edges of a plurality of vents;

FIG. 5 shows a gas separation type showerhead employing a gas injection module constructed with an insulator;

FIG. 6 shows a gas separation type showerhead employing a gas injection module in which an insulator and a conductor are joined each other;

FIGS. 7 to 11 show various shapes of a plurality of vents;

FIGS. 12 to 20 show various shapes of a plurality of holes; and

FIG. 21 shows a gas separation module and a gas injection module, each of which is supplied with power.

### DETAILED DESCRIPTION OF THE INVENTION

Hereinafter, exemplary embodiments of the present invention will be described in detail with reference to the accompanying drawings.

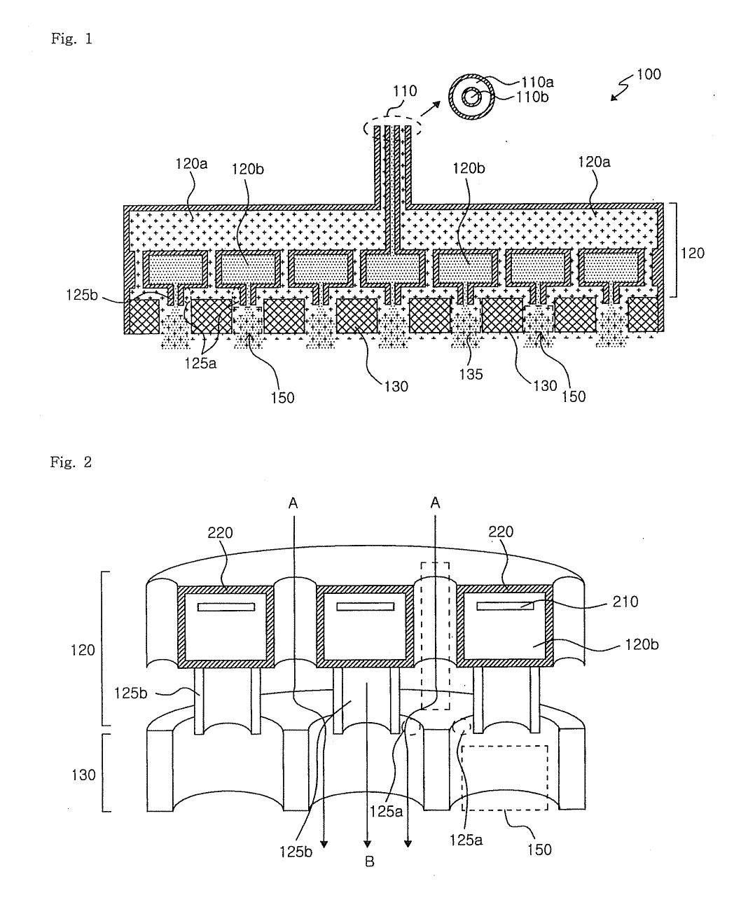

FIG. 1 shows a gas separation type showerhead according to an embodiment of the present invention. Referring to FIG. 1, a gas separation type showerhead 100 includes a gas supply module 110, a gas separation module 120, and a gas injection module 130.

A first gas A and a second gas B are separately supplied to the gas supply module 110. In order to separately provide the first gas A and the second gas B, the gas supply module 110 includes an outer supply tube 110a and an inner supply tube 110b which are separated from each other. Referring to FIG. 1, the first gas A is supplied to the outer supply tube 110a, and the second gas B is supplied to the inner supply tube 110b.

The first and second gases A and B supplied to the gas supply module 110 are separately dispersed in the gas separation module 120. In order to separately disperse the first and second gases A and, a first dispersion zone 120a is connected to the outer supply tube 110a of the gas supply module 110, and a second dispersion zone 120b is connected to the inner supply tube 110b of the gas supply module 110. Referring to FIG. 1, the first gas A is dispersed from the first dispersion zone 120a, and the second gas B is dispersed from the second dispersion zone 120b.

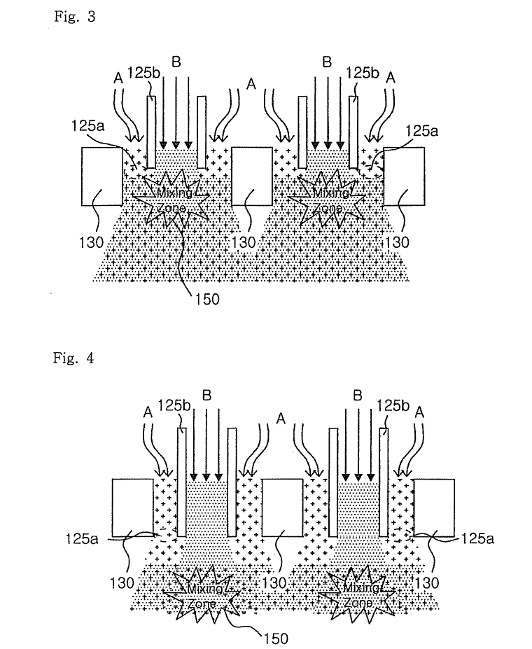

The first dispersion zone 120a is constructed with one region. The second dispersion zone 120b is located below the first dispersion zone 120a and is divided into a plurality of regions. Preferably, a gas distribution plate 210 (shown in FIG. 2) is provided to uniformly disperse the second gas B in the divided regions of the second dispersion zone 120b.

The divided regions of the second dispersion zone 120b are spaced apart from each other, that is, outer spaces are present between the outer surfaces of the divided regions. Further, a plurality of vents 125b are formed at the lower part of each of the regions of the second dispersion zone 120b.

FIG. 2 shows a three-dimensional cross-section of the gas separation module 120 and the gas injection module 130.

Referring to FIG. 2, the second gas B is vented to the gas injection module 130 through the vents 125b. The first gas A is vented to the gas injection module 130 from the first dispersion zone 120a to a space 125a surrounding each of the vents 125b via the outer spaces of the respective regions of the second dispersion zone 120b.

A lower part of the gas separation module 120, through which the first and second gases A and B are vented to the gas injection module 130, has a variable height which is determined according edge heights of the vents 125b.

The edges of the vents 125b may be located to be higher than the top of the gas injection module 130. Alternatively, the edges of the vents 125b may be located between the top and the bottom of the gas injection module 130.

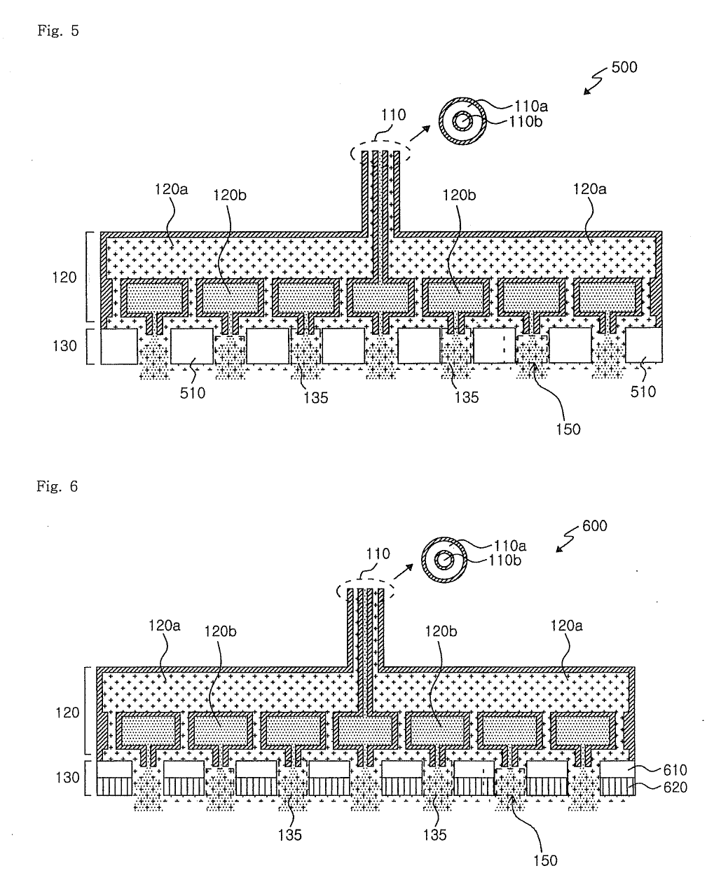

FIGS. 3 and 4 show locations of the edges of the vents 125b.

A mixing zone 150 in which the first and second gases A and B are mixed each other varies depending on the edge heights of the vents 125b.

If the edges of the vents 125b are located above the top of the gas injection module 130, the mixing zone 150 in which the first and second gases A and B are mixed can be widened within the showerhead. On the contrary, if the edges of the vents 125b are located between the top and the bottom of the gas injection module 130, the first and second gases A and B may maintain their original forms while the mixing of the first and second gases A and B are delayed.

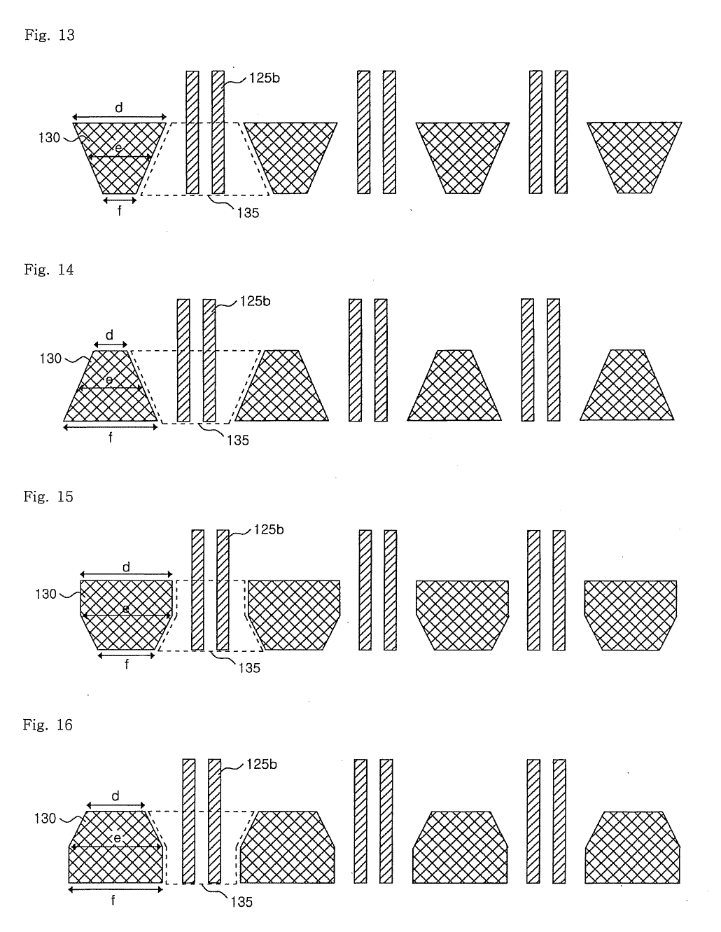

Referring to FIGS. 7 to 11, the vents 125b may be implemented in various shapes. If ‘a’ denotes a top width of one of the vents 125b, ‘b’ denotes a center width of one of the vents 125b, and ‘c’ denotes a bottom width of one of the vents 125b, then the vents 125b may have a typical shape of a=b=c (FIG. 7), or a shape with a widening edge of a=b<c (FIG. 8) and a<b=c (FIG. 10), or a shape with a narrowing edge of a>b=c (FIG. 9) and a=b>c (FIG. 11).

Eventually, the shapes of the vents 125b and the edge heights of the vents 125b are determined according to the purpose of processing.

The gas injection module 130 includes a plurality of holes 135. The first and second gases A and B separately dispersed from the gas separation module 120 are commonly injected into the chamber through the holes 135.

According to the purpose of processing, the first and second gases A and B may be simultaneously or sequentially injected into the chamber. Even if the first and second gases A and B are heterogeneous, the first and second gases A and B are not mixed until they are injected into the gas injection module 130. Therefore, in comparison with the case that the first and second gases A and B are mixed in advance, the first and second gases A and B can maintain their original forms, thereby being able to delaying ionization. Accordingly, ionization efficiency can be enhanced.

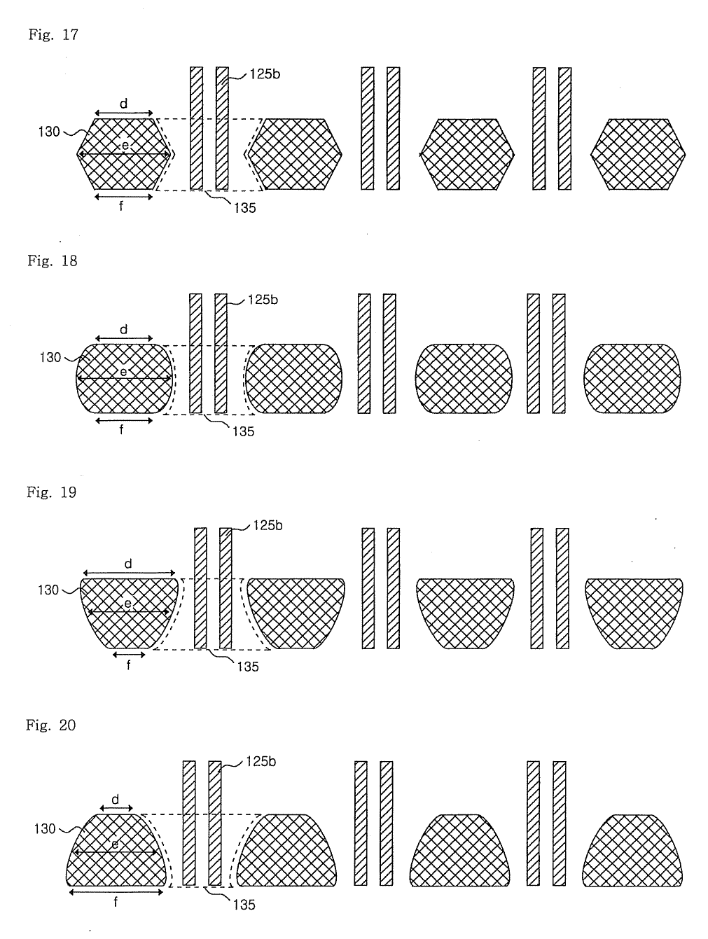

Similar to the vents 125b, the holes 135 may be implemented in various shapes as shown in FIGS. 12 to 20. Since the shape of the holes 135 is opposite to the shape of the gas injection module 130, the shape of the holes 135 can be described with the shape of the gas injection module 130.

If ‘d’ denotes a top width of the gas injection module 130, ‘e’ denotes a center width of the gas injection module 130, and ‘f’ denotes a bottom width of the gas injection module 130, then the holes 135 may have a shape with a constant injection width of d=e=f (FIG. 12), or a shape with a widening injection width of d>e>f (FIGS. 13 and 19) and d=e>f (FIG. 15), or a shape with a narrowing injection width of d<e<f (FIGS. 14 and 20), d<e=f (FIG. 16), and d=f<e (FIGS. 17 and 18).

Furthermore, as shown in FIGS. 13 and 19, FIGS. 14 and 20, and FIGS. 17 and 18, the shape of the holes may be implemented to be angular or rounded.

Therefore, according to the purpose of processing, the first and second gases A and B can be diversely injected in combination of the shapes of the vents 125b illustrated in FIGS. 7 to 11 and the shapes of the holes 135 illustrated in FIGS. 12 to 20.

According to the purpose of processing, in order to ionize one of the first gas A and the second gas B or to ionize both of the first gas A and the second gas B, ionization power is supplied to at least one of the gas separation module 120 and the gas injection module 130.

The ionization power may be selected from direct current (DC) power, radio frequency (RF) power, and microwave power.

In particular, if the ionization power is the RF power, the power may have a single frequency. Alternatively, two or more different frequencies may be mixed in the power. For example, when the ionization power is supplied to the gas separation module 120, the supplied power may have a single frequency of 13.56 MHz. Alternatively, frequencies of 13.56 MHz and 370 KHz may be mixed in the power.

In order to maintain the original forms of the first and second gases A and B prior to ionization when both of the first gas A and the second gas B are ionized, it is preferable that power is supplied to the gas injection module 130. In this case, the gas injection module 130 becomes a multi-hollow cathode including the holes 135. After the supply of power, the first and second gases A and B separately dispersed from the gas separation module 120 are ionized in the holes 135 to be commonly injected into the chamber.

The power may be supplied to a single point of the gas injection module 130. On the other hand, as the size of the showerhead increases, the power may be supplied to a plurality of points in the gas injection module 130.

When the edge heights of the vents 125b are located between the top and the bottom of the gas injection module 130, the second gas B can be ionized inside the vents 125b by supplying the ionization power of the first and second gases A and B to the gas injection module 130. That is, the second gas B can be ionized when electrons are supplied to inner spaces of the vents 125b by a plasma generated from the gas injection module 130 that becomes the multi-hollow cathode.

In order to ionize the first gas A in the gas separation module 120, power has to be supplied to the first dispersion zone 120a. In this case, the inner wall of the first dispersion zone 120a is preferably constructed with a conductor.

On the other hand, in order to ionize the second gas B in the gas separation module 120, power has to be supplied to the respective regions of the second dispersion zone 120b. For this, the inner walls of the respective regions of the second dispersion zone 120b may be constructed with conductors. In addition, the gas distribution plate 210 may be constructed with a conductor. In this case, an insulator (not shown) is preferably formed above and below the gas distribution plate 210.

If both of the first gas A and the second gas B are ionized in the gas separation module 120, in particular, if the first and second gases A and B have different ionization energies, the ionization power supplied to the first dispersion zone 120a may be different from the ionization power supplied to the second dispersion zone 120b or the gas distribution plate 210.

As shown in FIG. 2, if an outer wall 220 of the second dispersion zone 120b is constructed with the insulator, power supplied to the first dispersion zone 120a does not affect the second dispersion zone 120b, and power supplied to the second dispersion zone 120b does not affect the first dispersion zone 120a.

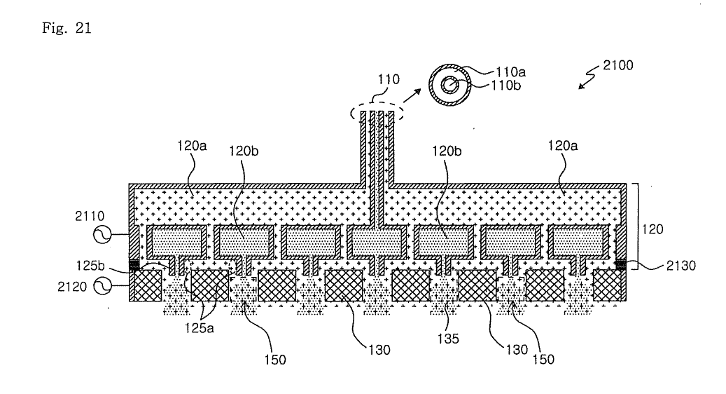

If an insulating ring 2130 (shown in FIG. 21) is present between the gas separation module 120 and the gas injection module 130, the gas separation module 120 and the gas injection module 130 can be electrically insulated from each other. In this case, even if the ionization power is supplied to one module, the other module is not affected due to the insulating ring 2130 (shown in FIG. 21).

Therefore, in the gas separation type showerhead 100 of the present invention, power can be supplied to specific points in the gas separation module 120 and the gas injection module 130 according to the purpose of processing.

If power is supplied nowhere in the gas separation type showerhead 100, the first and second gases A and B can maintain their original forms. Thus, the present invention can be applied to an ALD process and a thermal CVD process which are not accompanied with gas ionization.

In the case of the ALD process, the first gas A and the second gas B may be alternately provided to induce a reaction.

In the case of the thermal CVD process, if a section for gas mixture is long, particles may be generated. Further, the reaction may be terminated in the middle of the process. Accordingly, by using the gas separation type showerhead 100 of the present invention, the section for mixing the first and second gases A and B can be minimized, thereby enhancing process efficiency.

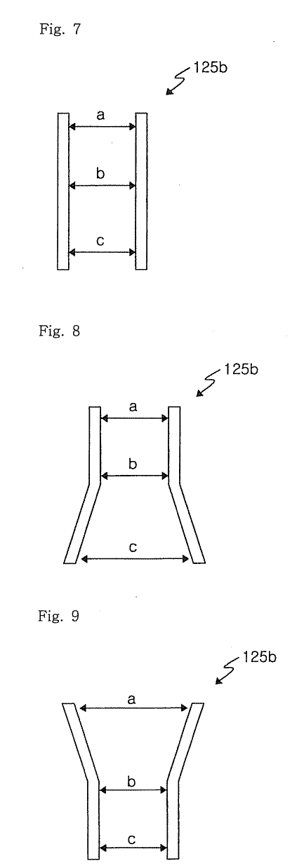

FIG. 5 shows a gas separation type showerhead according to anther embodiment of the present invention.

Referring to FIG. 5, the gas injection module 130 of a gas separation type showerhead 500 is constructed with an insulator 510. Further, at least one of the first gas A and the second gas B are ionized in the gas separation module 120.

The gas injection module 130 constructed with the insulator 510 can block an influence of plasma by means of the insulator 510. Thus, the influence of plasma can be minimized with respect to a semiconductor substrate and a heater which are disposed inside the chamber.

The insulator 510 may be made of a ceramic material (e.g., aluminum oxide (Al2O3) and aluminum nitride (AlN)) or a polymer material (e.g., Teflon). Alternatively, the insulator 510 may be made of a compound of the ceramic material and the polymer material.

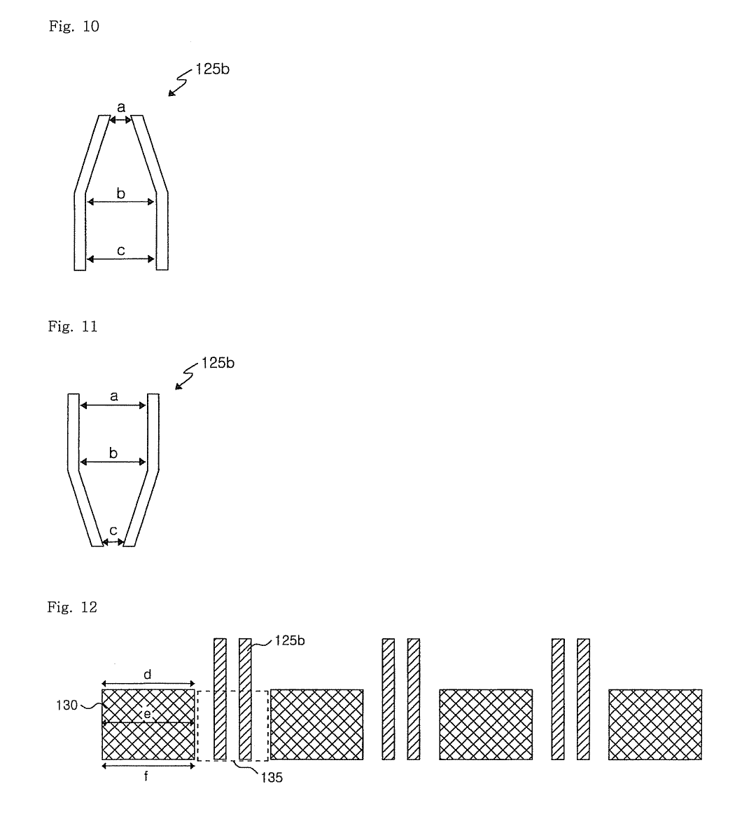

FIG. 6 shows a gas separation type showerhead according to still another embodiment of the present invention.

Referring to FIG. 6, the gas injection module 130 includes an upper plate 610 and a lower plate 620 which are joined each other.

The upper plate 610 is an insulator for blocking an influence of plasma. The lower plate 620 is a conductor such as aluminum (Al) that plays a role as a ground with respect to power.

In the embodiment of FIGS. 5 and 6, power is supplied to the gas separation module 120 for at least one of the first gas A and the second gas B. As described in the embodiment of FIG. 1, ionization power is supplied to at least one of the first dispersion zone 120a, the second dispersion zone 120b, and the gas distribution plate 210.

Eventually, in the showerheads 500 and 600 illustrated in FIGS. 5 and 6, the lower part of each showerhead is provided with an insulator. Thus, the dispersion surface of each showerhead is negligibly affected by plasma, thereby minimizing damage in a semiconductor substrate adjacent to a showerhead.

FIG. 21 shows a gas separation type showerhead 2100 of the present invention in which powers 2110 and 2120 are supplied both of the gas separation module 120 and the gas injection module 130.

In this case, the frequency of the power 2110 supplied to the gas separation module 120 may be different from the frequency of the power 2120 supplied to the gas injection module 130.

If an insulator ring 2130 is disposed between the gas separation module 120 and the gas injection module 130, the power 2110 supplied to the gas separation module 120 does not affect the gas injection module 130, and the power 2120 supplied to the gas injection module 130 does not affect the gas separation module 120. Therefore, an influence of power between the gas separation module 120 and the gas injection module 130 can be avoided.

Since the gas injection module 130 is adjacent to the semiconductor substrate within the chamber, the power 2120 supplied to the gas injection module 130 has a relatively low frequency. On the other hand, ionization of the first and second gases A and B is mainly achieved in the gas separation module 120. Thus, the power 2110 supplied to the gas separation module 120 has a relatively high frequency.

Accordingly, a gas separation type showerhead of the present invention is applied to a process or equipment requiring two or more heterogeneous gases. Further, the two or more gases can be uniformly supplied to a processing zone within a chamber.

In addition, in the gas separation type showerhead of the present invention, the location where the two or more gases are mixed can be selected depending on locations of a plurality of vents. Thus, there is an advantage in that a degree of gas mixing and a plasma reaction can be regulated.

While the present invention has been particularly shown and described with reference to exemplary embodiments thereof, the exemplary embodiments should be considered in descriptive sense only and not for purposes of limitation. Therefore, it will be understood by those skilled in the art that various changes in form and details may be made therein without departing from the spirit and scope of the invention as defined by the appended claims.

1. A gas separation type showerhead comprising:
a gas supply module to which a first gas and a second gas are separately supplied;
a gas separation module in which the supplied first and second gases are separately dispersed; and
a gas injection module which includes a plurality of holes and in which the first and second gases separately dispersed are commonly injected through the holes,
wherein a lower part of the gas separation module, through which the first and second gases are vented to the gas injection module, has a variable height.

2. The gas separation type showerhead of claim 1, further comprising an insulator ring which electrically insulates the gas separation module and the gas injection module.

3. The gas separation type showerhead of claim 1, wherein ionization power is supplied to at least one of the gas separation module and the gas injection module.

4. The gas separation type showerhead of claim 3, wherein the ionization power has a single frequency or a mixed frequency.

5. The gas separation type showerhead of claim 3, wherein, when the ionization power is supplied to both of the gas separation module and the gas injection module, power supplied to the gas separation module has a frequency different from that of power supplied to the gas injection module.

6. The gas separation type showerhead of claim 5, wherein the power supplied to the gas separation module has a frequency higher than that of the power supplied to the gas injection module.

7. The gas separation type showerhead of claim 1, wherein each hole has a shape selected from d=e=f, d>e>f, d<e<f, d=e>f, d<e=f, and d=f<e (where, ‘d’ denotes a top width of hole, ‘e’ denotes a center width of hole, and ‘f’ denotes a bottom width of hole).

8. The gas separation type showerhead of claim 7, wherein each hole has an angular shape or a rounded shape.

9. The gas separation type showerhead of claim 1, wherein the gas separation module comprises:
a first dispersion zone in which the first gas is dispersed and which is constructed with one region;
a second dispersion zone which is located below the first dispersion zone and is divided into a plurality of regions; and
a plurality of vents, each of which is formed at the lower part of each of the regions of the second dispersion zone, and from which the second gas is vented.

10. The gas separation type showerhead of claim 9, wherein the ionization power is supplied to at least one of the first dispersion zone and the second dispersion zone.

11. The gas separation type showerhead of claim 10, wherein the ionization power has a single frequency or a mixed frequency.

12. The gas separation type showerhead of claim 10, wherein, when the ionization power is supplied to both of the first and second dispersion zones, power supplied to the first dispersion zone has a frequency different from that of power supplied to the second dispersion zone.

13. The gas separation type showerhead of claim 9, wherein the second dispersion zone is provided with a gas distribution plate which uniformly disperses the second gas in the divided regions.

14. The gas separation type showerhead of claim 13, wherein ionization power is supplied to at least one of the first dispersion zone, the second dispersion zone, and the gas distribution plate.

15. The gas separation type showerhead of claim 14, wherein, when the ionization power is supplied to the gas distribution plate, an insulator is formed above and below of the gas distribution plate.

16. The gas separation type showerhead of claim 9, wherein the first gas is vented from the first dispersion zone to spaces surrounding each of the vents via outer spaces of the respective regions of the second dispersion zone.

17. The gas separation type showerhead of claim 9, wherein each edge of the vents is located higher than the top of the gas injection module.

18. The gas separation type showerhead of claim 9, wherein each edge of the vents is located between the top and the bottom of the gas injection module.

19. The gas separation type showerhead of claim 9, wherein each vent has a shape selected from a=b=c, a=b<c, a>b=c, a<b=c, and a=b>c (where, ‘a’ denotes a top width of the vent, ‘b’ denotes a center width of the vent, and ‘c’ denotes a bottom width of the vent).

20. A gas separation type showerhead comprising:
a gas supply module to which a first gas and a second gas are separately supplied;
a gas separation module in which the supplied first and second gases are separately dispersed; and
a gas injection module which is a multi-hollow cathode having a plurality of holes and in which the first and second gases separately dispersed are ionized in the holes to be commonly dispersed.

21. The gas separation type showerhead of claim 20, further comprising an insulator ring which electrically insulates the gas separation module and the gas injection module.

22. The gas separation type showerhead of claim 20, wherein ionization power is supplied to the gas injection module so as to ionize the first and second gases.

23. The gas separation type showerhead of claim 22, wherein the ionization power has a single frequency or a mixed frequency.

24. The gas separation type showerhead of claim 22, wherein the ionization power is supplied to a plurality of points in the gas injection module.

25. The gas separation type showerhead of claim 22, wherein the ionization power is selected from direct current (DC) power, radio frequency (RF) power, and microwave power.

26. The gas separation type showerhead of claim 20, wherein each hole has a shape selected from d=e=f, d>e>f, d<e<f, d=e>f, d<e=f, and d=f<e (where, ‘d’ denotes a top width of hole, ‘e’ denotes a center width of hole, and ‘f’ denotes a bottom width of hole).

27. The gas separation type showerhead of claim 26, wherein each hole has an angular shape or a rounded shape.

28. The gas separation type showerhead of claim 20, wherein the gas separation module comprises:
a first dispersion zone in which the first gas is dispersed and which is constructed with one region;
a second dispersion zone which is located below the first dispersion zone and is divided into a plurality of regions; and
a plurality of vents, each of which is formed at the lower part of each of the regions of the second dispersion zone, and from which the second gas is vented.

29. The gas separation type showerhead of claim 28, wherein the second dispersion zone is provided with a gas distribution plate which uniformly disperses the second gas to the divided regions.

30. The gas separation type showerhead of claim 28, wherein the first gas is vented from the first dispersion zone to spaces surrounding each of the vents via outer spaces of the respective regions of the second dispersion zone.

31. The gas separation type showerhead of claim 28, wherein each edge of the vents is located higher than the top of the gas injection module.

32. The gas separation type showerhead of claim 28, wherein each edge of the vents is located between the top and the bottom of the gas injection module.

33. The gas separation type showerhead of claim 32, wherein the second gas passing through the vents is ionized by plasma generated by the multi-hollow cathode.

34. The gas separation type showerhead of claim 28, wherein each vent has a shape selected from a=b=c, a=b<c, a>b=c, a<b=c, and a=b>c (where, ‘a’ denotes a top width of the vent, ‘b’ denotes a center width of the vent, and ‘c’ denotes a bottom width of the vent).

35. A gas separation type showerhead comprising:
a gas supply module to which a first gas and a second gas are separately supplied;
a gas separation module in which the supplied first and second gases are separately dispersed, and at least one of the first and second gases are ionized; and
a gas injection module which includes a plurality of holes and in which the first and second gases separately dispersed are commonly injected through the holes,
wherein at least a part of the gas injection module is an insulator.

36. The gas separation type showerhead of claim 35, wherein the insulator is made of a ceramic material, a polymer material, or a compound of the ceramic material and the polymer material.

37. The gas separation type showerhead of claim 35, wherein the gas injection module is constructed with only the insulator.

38. The gas separation type showerhead of claim 35, wherein the gas injection module is constructed with an upper plate and a lower plate which are joined with each other, and wherein the upper plate is an insulator and the lower plate is a ground conductor.

39. The gas separation type showerhead of claim 35, wherein the gas separation module comprises:
a first dispersion zone in which the first gas is dispersed and which is constructed with one region;
a second dispersion zone which is located below the first dispersion zone and is divided into a plurality of regions; and
a plurality of vents, each of which is formed at the lower part of each of the regions of the second dispersion zone, and from which the second gas is vented.

40. The gas separation type showerhead of claim 39, wherein the ionization power is supplied to at least one of the first dispersion zone and the second dispersion zone.

41. The gas separation type showerhead of claim 40, wherein the ionization power has a single frequency or a mixed frequency.

42. The gas separation type showerhead of claim 40, wherein, when the ionization power is supplied to both of the first and second dispersion zones, power supplied to the first dispersion zone has a frequency different from that of power supplied to the second dispersion zone.

43. The gas separation type showerhead of claim 39, wherein the second dispersion zone is provided with a gas distribution plate which uniformly disperses the second gas in the divided regions.

44. The gas separation type showerhead of claim 43, wherein ionization power is supplied to at least one of the first dispersion zone, the second dispersion zone, and the gas distribution plate.

45. The gas separation type showerhead of claim 44, wherein, when the ionization power is supplied to the gas distribution plate, an insulator is formed above and below the gas distribution plate.

46. The gas separation type showerhead of claim 39, wherein the first gas is vented from the first dispersion zone to spaces surrounding each of the vents via outer spaces of the respective regions of the second dispersion zone.
